(19) United States
(12) Patent Application Publication
(10) Pub. No.: US 2026/0257730 A1
(43) Pub. Date: Sep. 3, 2026

(54) DOOR ASSEMBLY

(71) Applicants: Hyundai Motor Company, Seoul (KR); Kia Corporation, Seoul (KR)

(72) Inventors: Won Ki Song, Hwaseong-si (KR); Joong Hyun Shin, Hwaseong-si (KR); Seung Yeon Lee, Hwaseong-si (KR); Hyung Sik Choi, Hwaseong-si (KR); Young Tae Kim, Hwaseong-si (KR); Gook Hyun Jeon, Hwaseong-si (KR); Yu Ri Myoung, Hwaseong-si (KR); Yong Ha Han, Hwaseong-si (KR); Soo Bok Kim, Hwaseong-si (KR); Min Young Lee, Hwaseong-si (KR)

(21) Appl. No.: 19/262,380

(22) Filed: Jul. 8, 2025

(30) Foreign Application Priority Data
Feb. 28, 2025 (KR) 10-2025-0026938

(51) Int. Cl. B62D 25/06; B60J 5/04

(52) U.S. Cl. CPC B62D 25/06; B60J 5/0479

(57) ABSTRACT

A clamshell door assembly can include a roof frame, an upper door mounting bracket coupled to the roof frame, a roof panel seated on the roof frame and covering the upper door mounting bracket, and an assembled frame connected to the roof frame and allowing the roof panel to be seated thereon.

### CROSS-REFERENCE TO RELATED APPLICATIONS

This application claims benefit of priority to Korean Patent Application No. 10-2025-0026938 filed on February 28, 2025 in the Korean Intellectual Property Office, the disclosure of which is incorporated herein by reference in its entirety.

### TECHNICAL FIELD

The present disclosure relates to a door assembly.

### BACKGROUND

There are various types of automobile doors. For example, there are swing type doors mainly applied to passenger cars, sliding type doors mainly applied to mid-sized passenger cars, and hatchback type doors mainly applied to the tailgates of passenger cars and recreational vehicles (RVs).

Meanwhile, purpose-built vehicles (PBVs) have emerged as future mobility vehicles. The possibility of expanding the functions and designs of PBVs according to the purposes thereof is significantly large. PBVs are a new type of mobility vehicle which are neither public transportation, such as buses nor personal passenger cars. Depending on which PBV is docked to a hub, the purpose of the hub itself may change and the hub may be used as a flexible space.

In future automobiles, tailgates may be installed not only at the rear of the vehicle but also on the side, allowing passengers to enter or exit the vehicle from the side, as well as for loading cargo. Among these types of tailgates, a ‘clamshell door,’ which is split in the middle and opens up and down, has come to prominence because it requires less force and takes up less rear space than when opening and closing a large single tailgate.

### SUMMARY

An embodiment of the present disclosure can provide a clamshell door assembly capable of improving structural stability by distributing a load applied to a roof frame.

An embodiment of the present disclosure can provide a clamshell door assembly with improved watertightness.

According to an embodiment of the present disclosure, a clamshell door assembly can include: a roof frame; an upper door mounting bracket coupled to the roof frame; a roof panel seated on the roof frame and covering the upper door mounting bracket; and an assembled frame connected to the roof frame and allowing the roof panel to be seated thereon.

According to an embodiment of the present disclosure, a clamshell door assembly can include: a roof frame; an upper door mounting bracket coupled to the roof frame; a roof panel mounted on the roof frame and covering the upper door mounting bracket; an upper door hinge coupled to the upper door mounting bracket; and an upper molding coupled to the upper door hinge.

### BRIEF DESCRIPTION OF THE DRAWINGS

The above and other features and advantages of example embodiments of the present disclosure can be more clearly understood from the following detailed description, taken in conjunction with the accompanying drawings, in which:

FIG. 1 is a schematic perspective view of a mobility frame equipped with a clamshell door assembly according to an embodiment of the present disclosure;

FIG. 2 is an exploded upper perspective view of FIG. 1;

FIG. 3 is an exploded lower perspective view of FIG. 1;

FIG. 4 is an enlarged view of portion A of FIG. 2;

FIG. 5 is an enlarged view of portion A of FIG. 2 viewed at a different angle than FIG. 4;

FIG. 6 is an exploded view of portion A of FIG. 2;

FIG. 7 is a cross-sectional view taken along line B-B’ of FIG. 1;

FIG. 8 is a cross-sectional view taken along line C-C’ of FIG. 1;

FIG. 9 is a perspective view illustrating an upper door according to an embodiment of the present disclosure;

FIG. 10 is an enlarged view of portion D of FIG. 9;

FIG. 11 is a perspective view of an upper molding according to an embodiment of the present disclosure;

FIG. 12 is a diagram illustrating a state of an upper molding during an upper door opening and closing operation according to an embodiment of the present disclosure;

FIG. 13 is a perspective view illustrating a lower door according to an embodiment of the present disclosure;

FIG. 14 is an enlarged view of portion E of FIG. 13;

FIG. 15 is a perspective view of a lower molding according to an embodiment of the present disclosure; and

FIG. 16 is a diagram illustrating a state of a lower molding during a lower door opening and closing operation according to an embodiment of the present disclosure.

### DETAILED DESCRIPTION OF ILLUSTRATIVE EMBODIMENTS

An embodiment of the present disclosure may be modified in various ways and take on various alternative forms, and specific example embodiments thereof are shown in the drawings and described in detail below. However, it can be understood that there is no intent to necessarily limit the present disclosure to the particular forms disclosed, but on the contrary, the present disclosure can cover modifications, equivalents, and alternatives falling within the spirit and scopes of the present disclosure.

It can be understood that, although the terms “first,” “second,” etc. may be used herein to describe various elements, these elements are not necessarily limited by these terms. These terms can be used merely to distinguish one element from another. For example, a first element could be termed a second element, and a second element could similarly be termed a first element without departing from the scope of the present disclosure. As used herein, the term “and/or” includes any and all combinations of one or more of the associated listed items.

Terms used herein to describe example embodiments of the present disclosure are not intended to necessarily limit the scopes of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It can be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different manner, terms used herein, including technical and scientific terms, can have same meanings as understood by those skilled in the art to which the present disclosure pertains. Terms defined in generally used dictionaries can be construed to have s same meanings as those of the contexts of the related art.

In the description below, terms “front,” “rear,” “upper,” “lower,” “top,” “bottom,” etc. used in relation to directions are described based on the illustration in the drawing.

Example embodiments of the present disclosure are described in detail with reference to the accompanying drawings.

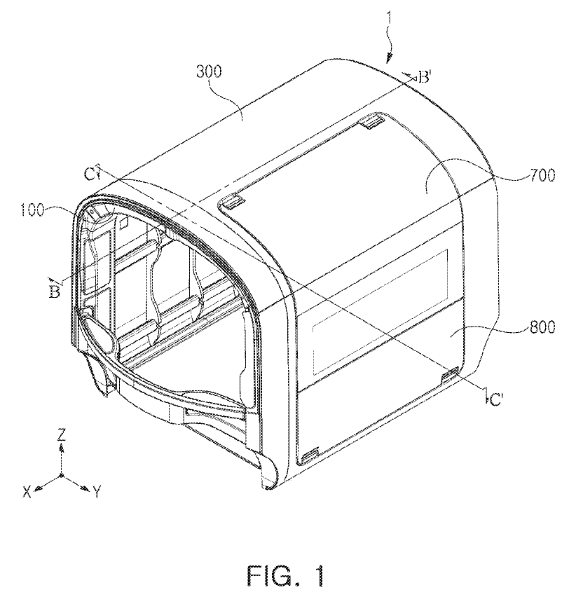

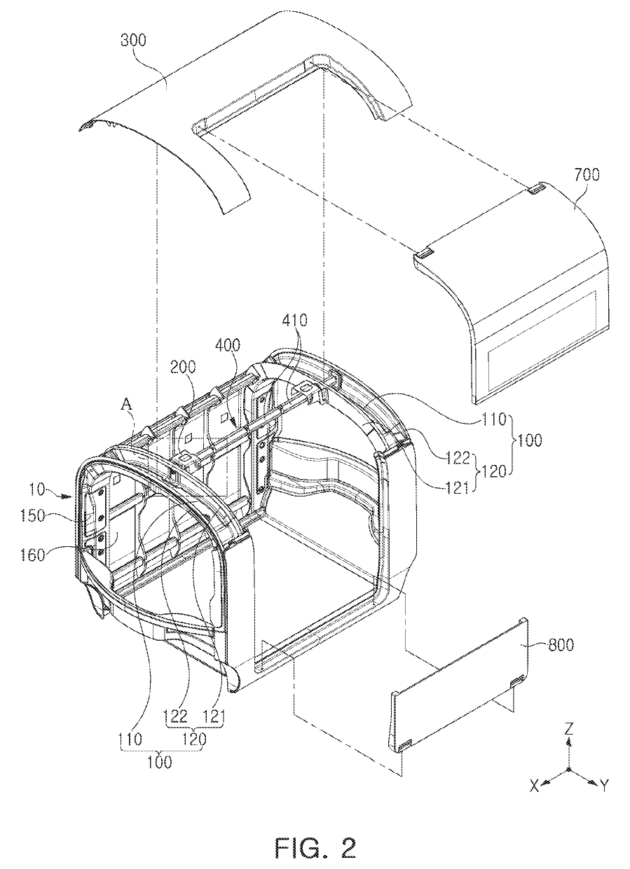

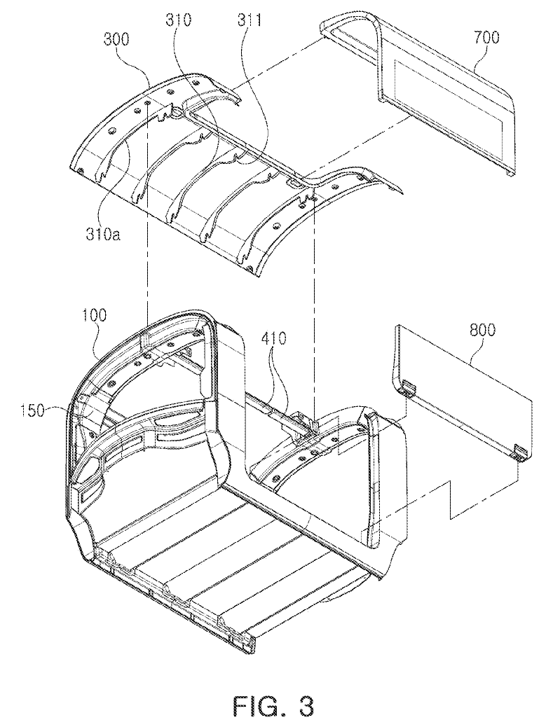

FIG. 1 is a schematic perspective view of a mobility frame equipped with a clamshell door assembly according to an embodiment of the present disclosure. FIG. 2 is an exploded upper perspective view of FIG. 1. FIG. 3 is an exploded lower perspective view of FIG. 1.

Referring to FIGS. 1 to 3, a clamshell door assembly 1 according to an embodiment of the present disclosure may include a roof frame 100, an upper door mounting bracket 200, a roof panel 300, and an assembled frame 400, any of, any combination of, or all of which may be in plural or may include plural components thereof. A clamshell door assembly 1 of an embodiment of the present disclosure can be for a vehicle passenger cabin and/or for a vehicle cargo area, which can be also a modular component for a vehicle body.

The roof frame 100 may be a component among a plurality of frames constituting a mobility frame 10 on which a clamshell door assembly 1 according to an embodiment of the present disclosure is installed. For example, the roof frame 100 may correspond to an upper frame to which the roof panel 300 is connected among the mobility frames 10. The roof frames 100 may be provided in pairs on both sides in a length direction, for example. In other words, the roof frame 100 may be provided on, for example, one side and the other side of the mobility frame 10 in the length direction, respectively. The length direction may refer to the X-axis direction in FIG. 1, a width direction may refer to the Y-axis direction in FIG. 1, and a thickness or height direction may refer to the Z-axis direction in FIG. 1. The roof frame 100 may be provided in a rail shape. For example, the roof frame 100 may include a base part 110 having a curved shape and side parts 120 bent upward from both lengthwise sides of the base part 110. The base part 110 may be bent downward toward both sides in the width direction. The side part 120 may include, for example, an inner side part 121 bent upward from a longitudinal inner side of the base part 110 and an outer side part 122 bent upward from a longitudinal outer side of the base part 110.

The roof panel 300 may be connected to the roof frame 100. For example, both longitudinal sides of the roof panel 300 may be seated on the roof frame 100 and connected thereto. The upper door mounting bracket 200 and the assembled frame 400 may be connected to the roof frame 100. For example, the upper door mounting bracket 200 and the assembled frame 400 may be connected to the inner side part 121 of the roof frame 100.

A side frame 150 may be coupled to a lower portion of the roof frame 100. The side frames 150 may be provided on widthwise lower sides of the roof frame 100, respectively. A side panel 160 may be provided between the side frames 150 provided on one widthwise side of the roof frame 100. An upper door 700 and a lower door 800 may be arranged between the side frames 150 provided on the other widthwise side of the roof frame 100. The upper door 700 may be rotatably coupled to an upper door hinge 500. The upper door hinge 500 may be connected to the upper door mounting bracket 200. The lower door 800 may be rotatably coupled to the lower door hinge 600. The lower door hinge 600 may be connected to a separate lower door mounting bracket (not shown).

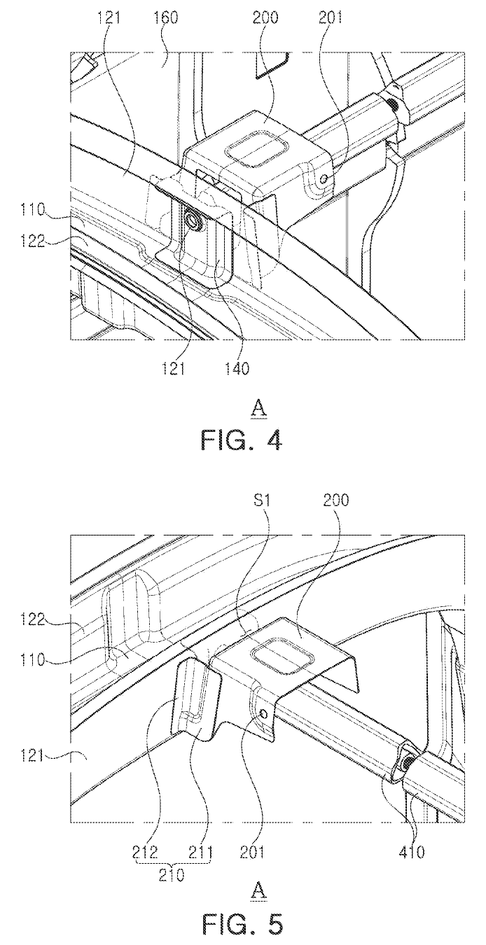

The upper door mounting bracket 200 may be coupled to the roof frame 100. For example, the upper door mounting bracket 200 may be at least partially welded to the roof frame 100 or coupled using a separate fastening device, such as a screw. The upper door mounting bracket 200 may be coupled to the inner side parts 121 of the roof frame 100 provided on both lengthwise sides. The upper door mounting bracket 200 may support the upper door 700. The upper door hinge 500 may be connected to the upper door mounting bracket 200. An upper door hinge coupling hole 201 for coupling the upper door hinge 500 may be provided to the upper door mounting bracket 200 (see FIG. 4). The upper door hinge 500 may be partially inserted into and coupled to the upper door hinge coupling hole 201. The upper door hinge 500 may rotatably support the upper door 700. When the upper door 700 rotates, a load of the upper door 700 may be transmitted to the roof frame 100 through the upper door hinge 500 and the upper door mounting bracket 200. The clamshell door assembly 1 according to an embodiment of the present disclosure may improve structural stability by distributing the load of the upper door 700. Details thereof will be described below.

The roof panel 300 may be connected to the roof frame 100. The roof panel 300 may be connected to the roof frame 100 to cover an upper portion of the mobility frame 10. At least one roof panel rib 310 may protrude from a bottom surface of the roof panel 300. The roof panel rib 310 may be mounted on the assembled frame 400. Through the roof panel rib 310, the load of the roof panel 300 may be evenly distributed to the assembled frame 400. A plurality of roof panel ribs 310 may be provided to be spaced apart from each other on the bottom surface of the roof panel 300 at a set, selected, or predetermined distance in the length direction. The roof panel rib 310 may be provided in a shape extending in the width direction. The roof panel rib 310 may be mounted on the assembled frame 400. The roof panel rib 310 may have a recess 311. The recess 311 may be provided such that a thickness-direction end of the roof panel rib 310 is recessed inward. At least a portion of the assembled frame 400 may be inserted into the recess 311. For example, at least a portion of the assembled frame 400 may be inserted into the recess 311. The roof panel rib 310 may be seated on the assembled frame 400 through the recess 311. One rib 310a of the roof panel ribs 310 may be inserted between one surface of the roof frame 100 and one surface of the upper door mounting bracket 200 facing the one surface of the roof frame 100 to contact the assembled frame 400.

The assembled frame 400 may be provided by connecting a plurality of frame parts 410. One frame part 410 may be screw-coupled to another frame part 410 having a longitudinal end disposed adjacently. The assembled frame 400 may be provided in plural. For example, the assembled frame 400 may be provided in plural and the plurality of assembled frames 400 may be spaced apart from each other in the width direction of the roof frame.

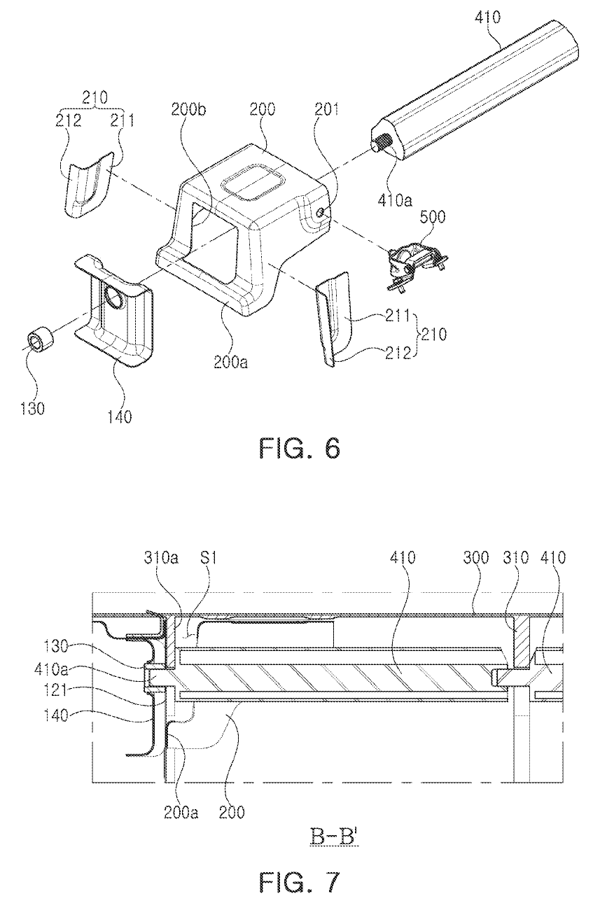

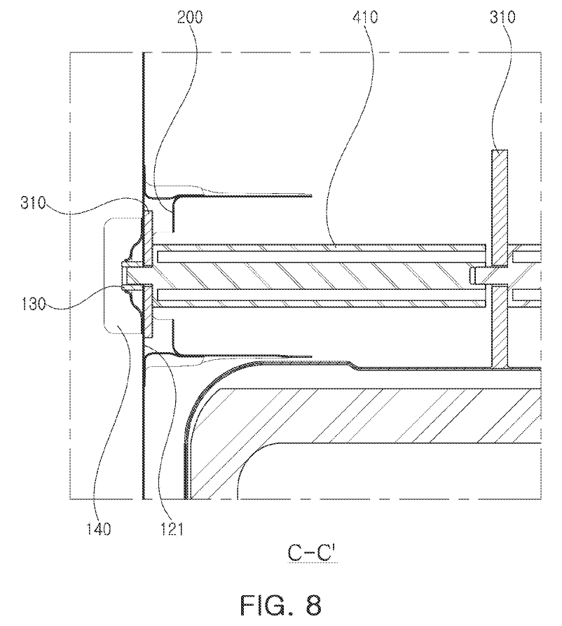

FIG. 4 is an enlarged view of portion A of FIG. 2. FIG. 5 is an enlarged view of portion A of FIG. 2 viewed at a different angle from FIG. 4. FIG. 6 is an exploded view of portion A of FIG. 2. FIG. 7 is a cross-sectional view taken along line B-B’ of FIG. 1. FIG. 8 is a cross-sectional view taken along line C-C’ of FIG. 1.

Referring to FIGS. 4 to 8, the upper door mounting bracket 200 may be coupled to the inner side part 121 of the roof frame 100. For example, the upper door mounting bracket 200 may be coupled to an inner surface of the inner side part 121 in the length direction. The upper door mounting bracket 200 may be welded to the inner side part 121 or may be coupled by a fastening device, such as a screw. A lower portion 200a of one surface of the upper door mounting bracket 200 facing the roof frame 100 may protrude to be bent toward the roof frame 100. Accordingly, a separation space S1 may be provided between the upper door mounting bracket 200 and the inner side part 121 of the roof frame 100. A roof panel rib 310 may be inserted into the separation space S1 and may be seated on the assembled frame 400. At least a portion of the lower portion 200a of the upper door mounting bracket 200 that protrudes to be bent may be welded to the inner side part 121 of the roof frame 100. The upper door mounting bracket 200 may include a through-hole 200b through which the assembled frame 400 can pass. An end portion of the assembled frame 400 may be connected to the inner side part 121 of the roof frame 100 by passing through the through-hole 200b.

A support flange 210 may be provided to support the upper door mounting bracket 200 and distribute the load of the upper door 700 transmitted to the upper door mounting bracket 200 to the roof frame 100. The support flange 210 may be connected to the inner side part 121 of the roof frame 100. The support flange 210 may be coupled to the inner side part 121 by, for example, welding or screwing. The support flange 210 may include, for example, a support part 211 contacting outer surfaces of both sides of the upper door mounting bracket 200 in the width direction and a coupling part 212 bent from one end portion of the support part 211 in the length direction and coupled to the inner side part 121. The coupling part 212 may be welded to the inner side part 121, for example. The support flange 210 may have a thickness-direction cross-section in an ‘L’ shape. The support flange 210 may be provided in pairs. In other words, the support flange 210 may be provided in a pair coupled to one surface of the inner side part 121 of the roof frame 100 at a set, selected, or predetermined distance. The inner surfaces of the pair of support flanges 210 may support one outer surface and the other outer surface of the upper door mounting bracket 200 in the width direction, respectively. The load of the upper door 700 transmitted to the upper door mounting bracket 200 may be distributed through the lower portion 200a of the upper door mounting bracket 200 and the support flange 210 and transmitted to the roof frame 100. Due to this load distribution, the structural stability of the clamshell door assembly 1 according to an embodiment of the present disclosure may be improved.

A pipe nut 130 and a pipe nut support 140 may be provided to distribute a load transmitted to the roof frame 100 by the assembled frame 400. The pipe nut 130 may be provided on the inner side part 121 of the roof frame 100. One end portion of the pipe nut 130 may contact a longitudinal outer surface of the inner side part 121. The assembled frame 400 may be coupled to the pipe nut 130 by penetrating through the roof frame 100. For example, the assembled frame 400 may be inserted into one end portion of the pipe nut 130 by penetrating through the inner side part 121. The assembled frame 400 and the pipe nut 130 may be screw-coupled. To this end, a screw part 410a having screw threads on an outer circumferential surface may be provided at one end portion of the frame part 410 of the assembled frame 400, and a screw recess that may be screw-coupled to the screw threads of the screw part 410a may be formed on the inner circumferential surface of the pipe nut 130.

The pipe nut support 140 may be in close contact with the roof frame 100. The pipe nut support 140 may be pressed against the pipe nut 130 so that at least a portion of the pipe nut support 140 may be in close contact with the roof frame 100. For example, when the assembled frame 400 is screw-coupled to one end portion of the pipe nut 130, the pipe nut support 140 may be pressed by the other end portion of the pipe nut 130 so as to be in close contact with the longitudinal outer surface of the inner side part 121. The pipe nut support 140 may distribute the load transmitted to the roof frame 100 by the assembled frame 400.

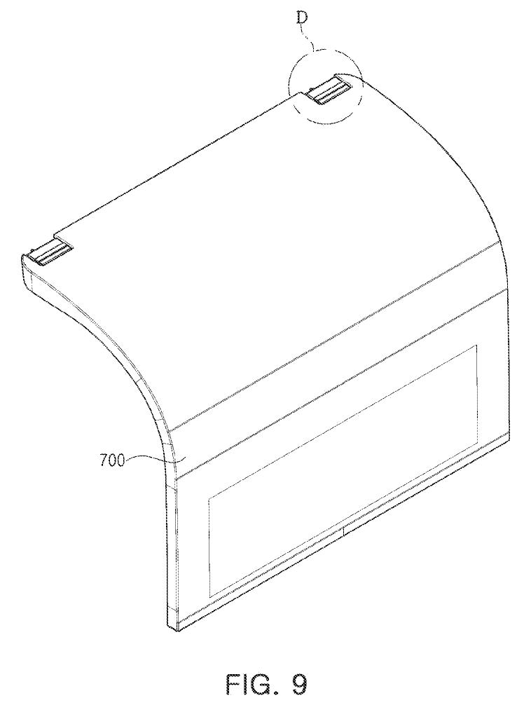

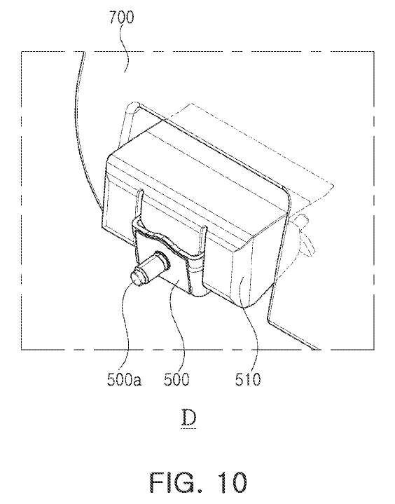

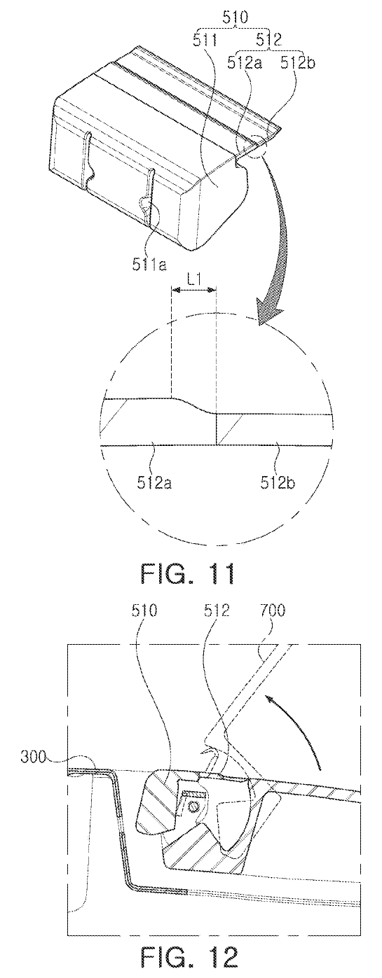

FIG. 9 is a perspective view illustrating an upper door according to an embodiment of the present disclosure. FIG. 10 is an enlarged view of portion D of FIG. 9. FIG. 11 is a perspective view of an upper molding according to an embodiment of the present disclosure. FIG. 12 is a diagram illustrating a state of an upper molding during an upper door opening and closing operation according to an embodiment of the present disclosure.

Referring to FIGS. 9 to 12, the upper door 700 may be connected to the upper door hinge 500. The upper door hinge 500 may be connected to the upper door mounting bracket 200. For example, the upper door hinge 500 may be provided with an upper coupling shaft 500a, and the upper coupling shaft 500a may be inserted into a hinge coupling hole 201 of the upper door mounting bracket 200 so that the upper door hinge 500 may be coupled to the upper door mounting bracket 200. The upper door hinge 500 may rotatably support the upper door 700. An upper molding 510 may be detachably coupled to the upper door hinge 500.

The upper molding 510 may be provided to prevent external foreign substances from entering the space in which the upper door hinge 500 is disposed and to improve watertightness. The upper molding 510 may include an upper molding part 511 into which the upper door hinge 500 is inserted and a soft (flexible) upper lip part 512 provided on one side of the upper molding part 511. An upper insertion slit 511a may be provided in the upper molding part 511. The upper insertion slit 511a may be provided in a shape into which the upper door hinge 500 may be inserted to correspond to the outer shape of the upper door hinge 500. At least a portion of the upper door hinge 500 may be inserted into the upper insertion slit 511a.

The upper lip part 512 may be formed of an elastic soft material (flexible). The upper lip part 512 may be bent or unbent in response to the rotation of the upper door 700 to block external foreign substances and water from flowing into the space in which the upper door hinge 500 is disposed. The upper lip part 512 may include a section L1 in which a thickness decreases from one end connected to the upper molding part 511 to the other end. For example, the upper lip part 512 may include a relatively thick upper inner lip 512a and a relatively thin upper outer lip 512b. When the upper door 700 rotates, the upper outer lip 512b may bend relatively more than the upper inner lip 512a to maintain contact with the upper door 700.

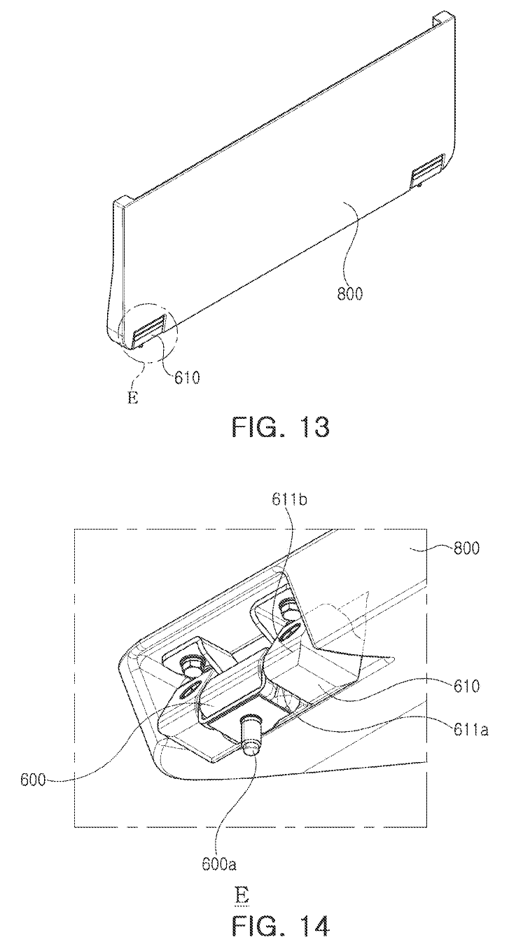

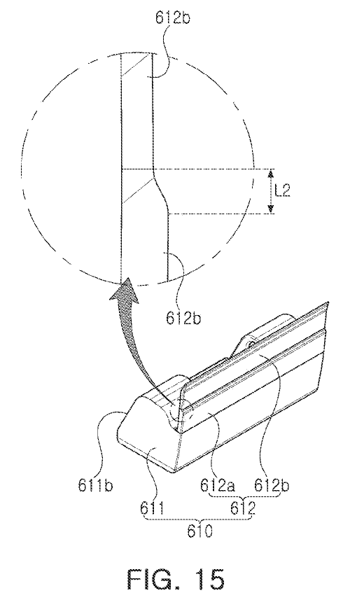

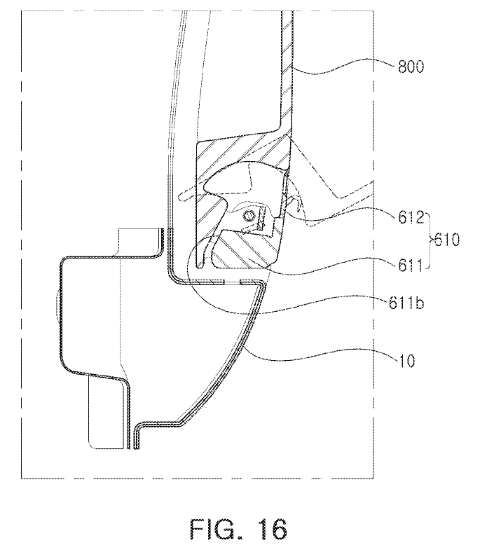

FIG. 13 is a perspective view illustrating a lower door according to an embodiment of the present disclosure. FIG. 14 is an enlarged view of portion E of FIG. 13. FIG. 15 is a perspective view of a lower molding according to an embodiment of the present disclosure. FIG. 16 is a diagram illustrating a state of a lower molding during a lower door opening and closing operation according to an embodiment of the present disclosure.

Referring to FIGS. 13 to 16, a lower door 800 may be connected to a lower door hinge 600. The lower door hinge 600 may be connected to a separate lower door mounting bracket (not shown) provided below the mobility frame 10. For example, the lower door hinge 600 may be provided with a lower coupling shaft 600a, and the lower coupling shaft 600a may be inserted into the lower door mounting bracket so that the lower door hinge 600 may be coupled to the lower door mounting bracket.

The lower door hinge 600 may rotatably support the lower door 800. A lower molding 610 may be detachably coupled to the lower door hinge 600.

The lower molding 610 may be provided to prevent external foreign substances from entering the space in which the lower door hinge 600 is disposed and to improve watertightness. The lower molding 610 may include a lower molding part 611 into which the lower door hinge 600 is inserted and a soft (flexible) lower lip part 612 provided on one side of the lower molding part 611. The lower molding part 611 may be provided with a lower insertion slit 611a. The lower insertion slit 611a may be provided in a shape into which the lower door hinge 600 may be inserted to correspond to the outer shape of the lower door hinge 600. At least a portion of the lower door hinge 600 may be inserted into the lower insertion slit 611a. The lower molding part 611 may include a slope 611b. The slope 611b may be provided to prevent interference of the lower door 800 when the lower door 800 rotates. The slope 611b may be provided in various shapes corresponding to the shape of the lower door 800. In other words, the slope 611b may be replaced with various shapes that may prevent interference when the lower door 800 rotates.

The lower lip part 612 may be formed of an elastic soft material (flexible). The lower lip part 612 may be bent or unbent in response to the rotation of the lower door 800 to block external foreign substances and water from flowing into the space in which the lower door hinge 600 is disposed. The lower lip part 612 may include a section L2 in which a thickness decreases from one end connected to the lower molding part 611 to the other end. For example, the lower lip part 612 may include a lower inner lip 612a having a relatively large thickness and a lower outer lip 612b having a relatively small thickness. When the lower door 800 rotates, the lower outer lip 612b may be bent relatively more than the lower inner lip 612a to maintain contact with the lower door 800.

A clamshell door assembly according to an embodiment of the present disclosure may improve structural stability.

A clamshell door assembly according to an embodiment of the present disclosure may improve watertightness.

While example embodiments have been shown and described above, it can be apparent to those skilled in the art that modifications and variations can be made without departing from the scopes of the present disclosure as defined by the appended claims and equivalents thereof.

What is claimed is:

1. A clamshell door assembly comprising:
a roof frame;
an upper door mounting bracket coupled to the roof frame;
a roof panel seated on the roof frame and covering the upper door mounting bracket; and
an assembled frame connected to the roof frame and allowing the roof panel to be seated on the assembled frame.

2. The assembly of claim 1, wherein a lower portion of the upper door mounting bracket facing the roof frame protrudes and is bent toward the roof frame and is coupled to the roof frame.

3. The assembly of claim 1, further comprising a roof panel rib protruding from a bottom surface of the roof panel and seated on the assembled frame.

4. The assembly of claim 3, wherein the roof panel rib is inserted between a roof-frame surface of the roof frame and a surface of the upper door mounting bracket facing the roof-frame surface and comes into contact with the assembled frame.

5. The assembly of claim 3, wherein the roof panel rib includes a recess into which at least a portion of an upper portion of the assembled frame is inserted.

6. The assembly of claim 1, further comprising a pair of support flanges coupled to a surface of the roof frame and spaced apart from each other at a first distance, wherein an inner surface of the support flange is in contact with an outer surface of the upper door mounting bracket.

7. The assembly of claim 1, further comprising a pipe nut having a first pipe-nut end portion in contact with the roof frame, wherein the assembled frame is inserted into and connected to the first pipe-nut end portion of the pipe nut through the roof frame.

8. The assembly of claim 7, further comprising a pipe nut support pressed against a second pipe-nut end portion of the pipe nut so that at least part of the pipe nut is in contact with the roof frame.

9. The assembly of claim 8, wherein the roof frame comprises:
a base part bent downwardly on both sides thereof in a width direction and curved;
an inner side part bent upwardly from a longitudinal inner side of the base part; and
an outer side part bent upwardly from a longitudinal outer side of the base part, wherein the pipe nut support contacts a longitudinal outer surface of the inner side part, and the upper door mounting bracket contacts a longitudinal inner surface of the inner side part.

10. A clamshell door assembly comprising:
a roof frame;
an upper door mounting bracket coupled to the roof frame;
a roof panel mounted on the roof frame and covering the upper door mounting bracket;
an upper door hinge coupled to the upper door mounting bracket; and
an upper molding coupled to the upper door hinge.

11. The assembly of claim 10, wherein the upper molding comprises:
an upper molding part into which the upper door hinge is inserted; and
a flexible upper lip part disposed on and extending from a first side of the upper molding part.

12. The assembly of claim 11, wherein the flexible upper lip part has a first thickness adjacent the upper molding part, wherein the flexible upper lip part transitions to a second thickness more distal from the upper molding part, and wherein the second thickness is less than the first thickness.

13. The assembly of claim 10, further comprising:
a side frame coupled to a lower portion of the roof frame;
a lower door hinge coupled to the side frame; and
a lower molding coupled to the lower door hinge.

14. The assembly of claim 13, wherein the lower molding comprises:
a lower molding part into which the lower door hinge is inserted; and
a flexible lower lip part disposed on and extending from a first side of the lower molding part.

15. The assembly of claim 14, wherein the flexible lower lip part has a first thickness adjacent the lower molding part, wherein the flexible lower lip part transitions to a second thickness more distal from the lower molding part, and wherein the second thickness is less than the first thickness.

16. A vehicle body comprising:
a first roof frame extending in a width direction of the vehicle body;
a first upper door mounting bracket fixed to a first-roof-frame inner surface of the first roof frame;
a roof panel mounted on and at least partially supported by the first roof frame, such that the roof panel covers the first upper door mounting bracket;
a first upper door hinge; and
a clamshell door coupled to the first upper door mounting bracket via the first upper door hinge, such that the clamshell door is configured to cover and uncover at least part of a clamshell door opening of the vehicle body.

17. The vehicle body of claim 16, further comprising:
a second roof frame extending in the width direction of the vehicle body, wherein the second roof frame is spaced apart from the first roof frame in a longitudinal direction of the vehicle body, wherein the roof panel is mounted on and at least partially supported by the second roof frame;
a roof support frame extending in the longitudinal direction between the first roof frame and the second roof frame, wherein the roof support frame is connected to the first roof frame and the second roof frame; and
roof panel ribs protruding from an inner roof-panel surface of the roof panel and each extending in the width direction of the vehicle body, wherein the roof panel ribs are coupled to the roof support frame such that the roof panel is at least partially supported by the roof support frame via the roof panel ribs.

18. The vehicle body of claim 17, wherein each of the roof panel ribs includes roof-panel-rib recess openings that receive therein at least part of the roof support frame.

19. The vehicle body of claim 16, further comprising a first upper molding coupled to the first upper door hinge, such that at least part of the first upper door hinge is within the first upper molding.

20. The vehicle body of claim 19, further comprising:
a second roof frame extending in the width direction of the vehicle body, wherein the second roof frame is spaced apart from the first roof frame in a longitudinal direction of the vehicle body, wherein the roof panel is mounted on and at least partially supported by the second roof frame;
a roof support frame extending in the longitudinal direction between the first roof frame and the second roof frame, wherein the roof support frame is connected to the first roof frame and the second roof frame;
roof panel ribs protruding from an inner roof-panel surface of the roof panel and each extending in the width direction of the vehicle body, wherein the roof panel ribs are coupled to the roof support frame such that the roof panel is at least partially supported by the roof support frame via the roof panel ribs;
a second upper door mounting bracket fixed to a second-roof-frame inner surface of the second roof frame;
a second upper door hinge, wherein the clamshell door is coupled to the second upper door mounting bracket via the second upper door hinge; and
a second upper molding coupled to the second upper door hinge, such that at least part of the second upper door hinge is within the second upper molding, wherein each of the first upper molding and the second upper molding comprises:
an upper molding part into which the first upper door hinge or the second upper door hinge is inserted, and
a flexible upper lip part disposed on and extending from a first side of the upper molding part, wherein the flexible upper lip part has a first thickness adjacent the upper molding part, wherein the flexible upper lip part transitions to a second thickness more distal from the upper molding part, and wherein the second thickness is less than the first thickness.
